(19) United States
(12) Patent Application Publication
(10) Pub. No.: US 2008/0072433 A1
(43) Pub. Date: Mar. 27, 2008

(54) Portable powder scoop

(75) Inventors: Avi Ohring, Hoboken, NJ (US); Donald Kralik, Garwood, NJ (US)

Correspondence Address: AUFRICHTIG & AUFRICHTIG, P.C., 300 EAST 42ND STREET, 5th Floor, NEW YORK, NY, 10017, US

(73) Assignees: Avi Ohring; Donald Kralik

(21) Appl. No.: 11/904,075

(22) Filed: Sep. 26, 2007

Related U.S. Application Data
(60) Provisional application No. 60/847,243, filed on Sep. 26, 2006.

(51) Int. Cl. B26B 11/00

(52) U.S. Cl. 30/125

(57) ABSTRACT

A portable metered delivery system for sealably carrying and dispensing powder having a tubular container with open and closed ends to receive and contain powder therein and a removable cap with a base portion and a scoop portion. The removable cap projects longitudinally from the open end of the tubular container to dispense the powder into a bottle. The system also includes an insert with an open section allowing the powder to pass through and a closed section for preventing release of the powder. The insert is disposed between the tubular container and the removable cap. When the removable cap is rotated about the tubular container to expose the open section or closed section the amount of powder being dispense can be controlled.

### CROSS-REFERENCE TO RELATED APPLICATIONS

This application claims the priority of provisional application Ser. No. 60/847,243 filed in the United States Patent and Trademark Office on Sep. 26, 2006.

### BACKGROUND OF THE INVENTION

One of the most important factors affecting athletic performance is the need to stay adequately hydrated. This is particularly important in endurance sports such as competitive cycling and distance running. These activities are unique in that they require the athlete to hydrate while performing the activity. There are no timeouts, halftimes, breaks etc. During actual competition hydration is usually provided by the event manager on the side lines, however during training the athlete must provide his own.

Proper hydration for an athlete has three basic requirements: (1) Water—It is a given that no strenuous physical activity can be maintained for extended periods without water; (2) Electrolyte Replacement—Extensive physical activity causes us to sweat. Sweat including significant amounts of Sodium and Potassium which must be replaced as well; and (3) Carbohydrates—In order to maintain high energy levels we need to replace the calories we are burning. Failure to do so may cause a condition known as ‘bonking’ in which the body shuts down all unnecessary functions and the athlete can not take another step.

In the mid 1960's the first commercially produced sports drinks were introduced to address these needs. Although these products addressed the three basic hydration requirements, the problem with sports drinks is that they are in liquid form, which is heavy and difficult to transport. In order to solve this ‘transport’ issue, a number of solutions were developed in subsequent years. Some of the solutions focused on creating ergonomic methods of transporting liquids such as improved sports bottles, hydration belts or hydration backpacks. However, with a gallon of water weighing about eight pounds these solutions were not ideal.

Runners and cyclists typically take a route where they know the location of public water sources. However, water alone is not adequate for proper re-hydration. Athletes sometimes pre-mix a large quantity of sports drink and deal with the added weight or take a smaller amount of sports drink and switch to water when it is time to refill at a public tap. Some athletes will try to take a sports drink powder in a plastic baggie, film canister, salt shaker etc., however these homegrown methods have proven to be problematic. None of these items were designed to dispense a powder in what could potentially be a harsh outdoor environment or while in motion.

Another solution that has been marketed, is the use of disposable powder packets. Even though this method has been found to be a decent solution, the disposal of the packets has become an environmental issue. The users of the packets usually discard the packets while in the midst of training so the packets are not placed in a proper disposal receptacle.

There have been some scoop designs that share some elements with that of the present invention. U.S. Design Pat. No. D294,299 for a Medicine Dosage Spoon. This design patent shows a plastic spoon having a tubular container portion with a spoon shaped end for receiving the substance to be administered. This design does not disclose that the spoon is sealable for transporting the substance therein.

U.S. Pat. No. 5,119,560 discloses a Medicine Dosage Device having a tubular container closed at one end, and its open end includes an integrally formed spoon. A portion of the side wall of the container at the open end is cut away, leaving a dispensing spoon having a curvature that is the same as the tubular side wall. The dosage device further includes a sealing cap that slides over the spoon, sealing the entire open end of the dosage device. At the same time, the outer and inner surfaces of the spoon are sealed from the medicine as well as the outside environment, regardless of the position of the spoon. The downfall to this device is that it is not operable with one hand. To use this device, the user would have to use both hands to unscrew the sealing cap before pouring the substance into water of the like.

U.S. Pat. No. 7,219,796 discloses a two piece sealed capsule that is inserted into a neck of a liquid bearing container. The capsule is a container or receptacle for sealably containing a liquid and/or dry material and a dispenser for releasing the material when desired into the container. The top of the capsule is depressed manually forcing two or more blade like prongs against the bottom of the capsule ripping a portion away, dispensing the material. This device allows for single handed use but it is not reusable. This device is not fillable by the user, rather, it is sold by companies with water bottles or other liquids. Accordingly, the user cannot make a drink mixture to his/her liking as provided by the present invention.

Accordingly, there is a need for a device which will allow the user to make an effective re-hydration drink while on the move without the need to carry a large amount of heavy liquid and can be done easily, preferably with one hand. There is also a need for a device that is environmental friendly in that it is reusable.

### SUMMARY OF THE INVENTION

The invention is generally directed to a portable metered delivery system for easily dispensing and mixing a powder with water in any size water or sports bottle.

The device offers athletes and other individuals interested in proper hydration an alternative to carrying or purchasing large amounts of beverages. By carrying a lightweight inexpensive powder in a portable delivery system the user can create a beverage anywhere there is access to potable water.

An object of the present invention is to make the portable metered delivery system compatible with powdered beverage mixes and suitable for use with all bottled water and water bottles.

A further object of the invention is to make the portable metered delivery system small in size and weight so that it can be easily carried.

A further object of the present invention is to make an environmentally friendly portable metered delivery system that can be reusable.

Still a further object is to make a device that is water resistant to prevent premature contact with water and to prevent caking of the powder.

Yet another object is to make the portable metered delivery system simple to use via one handed operation allowing its use without slowing the user down.

Still other objects and advantages of the invention will, in part, be obvious and will, in part, be apparent from the specification.

The invention accordingly comprises the features of construction, combinations of elements and arrangements of parts which will be exemplified in the construction as hereinafter set forth, and the scope of the invention will be indicated in the Claims.

### BRIEF DESCRIPTION OF THE DRAWINGS

For a fuller understanding of the invention, reference is made to the following description taken in connection with the accompanying drawings, in which:

FIG. 1 is an exploded view of a preferred embodiment of the portable metered delivery system;

FIG. 2 shows a side view of the insert of the embodiment shown in FIG. 1;

FIG. 3 shows a perspective view of the insert of the embodiment shown in FIG. 1;

FIG. 4 is a side perspective view of the portable metered delivery system according to another embodiment of the present invention;

FIG. 5 is a perspective view looking down into the portable metered delivery system of the embodiment of FIG. 1 into the open end showing the insert open;

FIG. 6 is a perspective view looking down into the portable metered delivery system of the embodiment of FIG. 1 into the open end showing the insert open;

FIG. 7 is the attachment of two portable metered delivery system devices of FIG. 1; and

FIG. 8 is another embodiment of the portable metered delivery system.

### DETAILED DESCRIPTION OF THE PREFERRED EMBODIMENTS

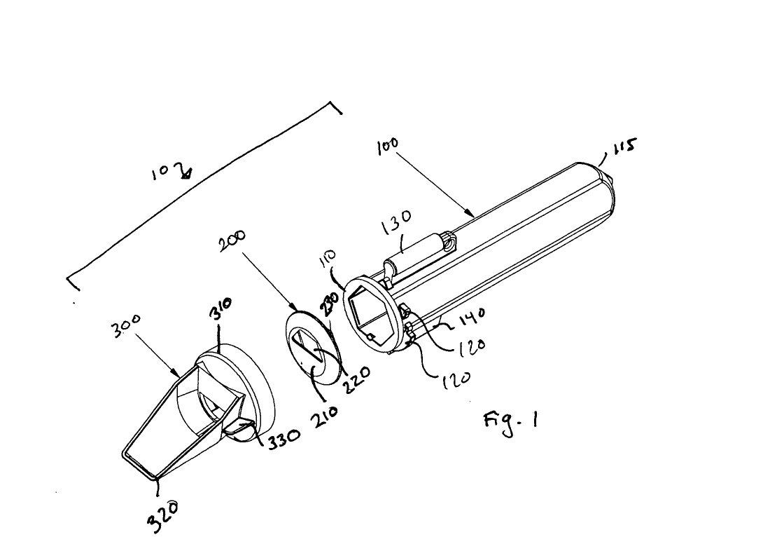

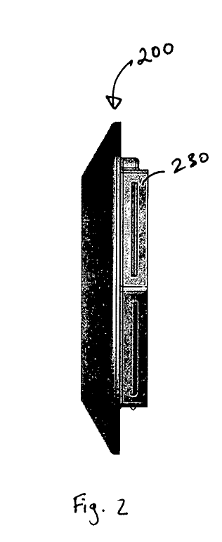

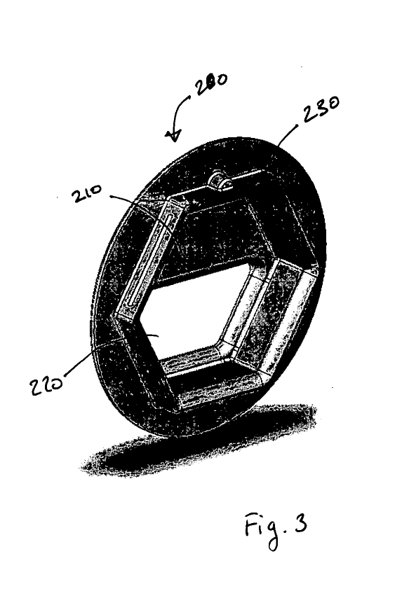

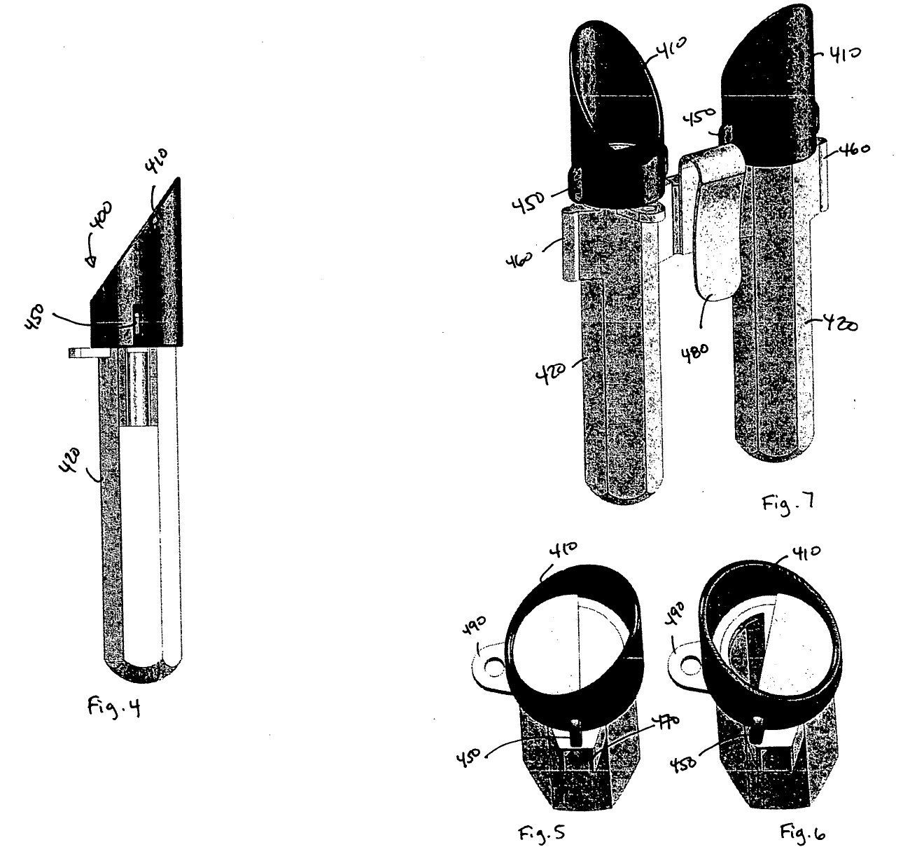

A preferred embodiment of the portable metered delivery system 10 in accordance with the invention is shown in FIGS. 1-3 which consists of three elements. The body 100, insert 200 and cap 300. Body 100 is multi-sided, preferably a six sided, hexagonal shaped, tubular container, but can be of other shapes and sizes. This shape allows for a better grip by the user, especially when the user is in motion and potentially has sweaty hands. The cylinder is open at one end 110 and closed at the other end 115. Insert 200 is inserted at the top of the open end of the cylinder 110. As seen in more detail in FIGS. 2-3, insert 200 is designed to have a tight fit with the open end 110 such that the insert does not rotate as the cap is turned. This is accomplished by having an attachment portion 230 extending from the bottom of the insert. In a preferred embodiment, the attachment portion is also multi-sided, preferably a six-sided, hexagonal shaped element that snaps into the open end of the body. Alternatively, the inner band surface of the insert can be the hexagonal shape of the tube 100. When the insert is in place, it reduces the amount of material that can flow in and out of the body by 50%. Insert 200 contains a closed surface 210 and an open area 220. This insert controls the amount of powder being expelled from the device when in use. The user can control the amount of the powder poured into the liquid by turning the cap a certain number of degrees to expose the open area 220 of the insert. For example, as shown in FIGS. 5 and 6, a 90 degree turn allows half the open part of the insert to be exposed and a 180 degree turn allows a full opening of the insert to be exposed for maximum powder release.

As seen in FIG. 1, cap 300 contains a base portion 310 and a scoop portion 320. Base portion 310 connects to the body for example, by screwing together, snapping on or any other type of attachment mechanism. Cap 300 is shaped like a spoon/scoop to allow the powder or other substance to be scooped or dispensed. When the cap is in place it can rotate 180 degrees in a clock wise or counter clock wise direction. The cap is rotated counter clock wise 180 degrees to be in the ‘open’ position. Actuation tabs 330 are attached to opposite sides of the cap so that the user can easily turn the cap to the open and closed positions by applying pressure to actuation tabs 330 with their fingers.

As seen in FIGS. 5 and 6, when the device is in the open position, the sealed half of the cap is directly above the sealed half of the neck insert allowing the substance to flow in or out of the of the opening. When the cap is rotated 180 degrees in a clock wise direction the unit is sealed. When the device is in the sealed position, the sealed half of the scoop is on the opposite side of the neck insert causing the opening at the end of the body to be fully covered thus sealing the open end. Around the open end of the cylinder are a series of detents 120 that provide a tactile feedback regarding the position of the cap as it rotates. Accordingly, the user can feel when the cap is a certain position and know how much powder is being released and the user will also be able to tell when the cap is completely closed.

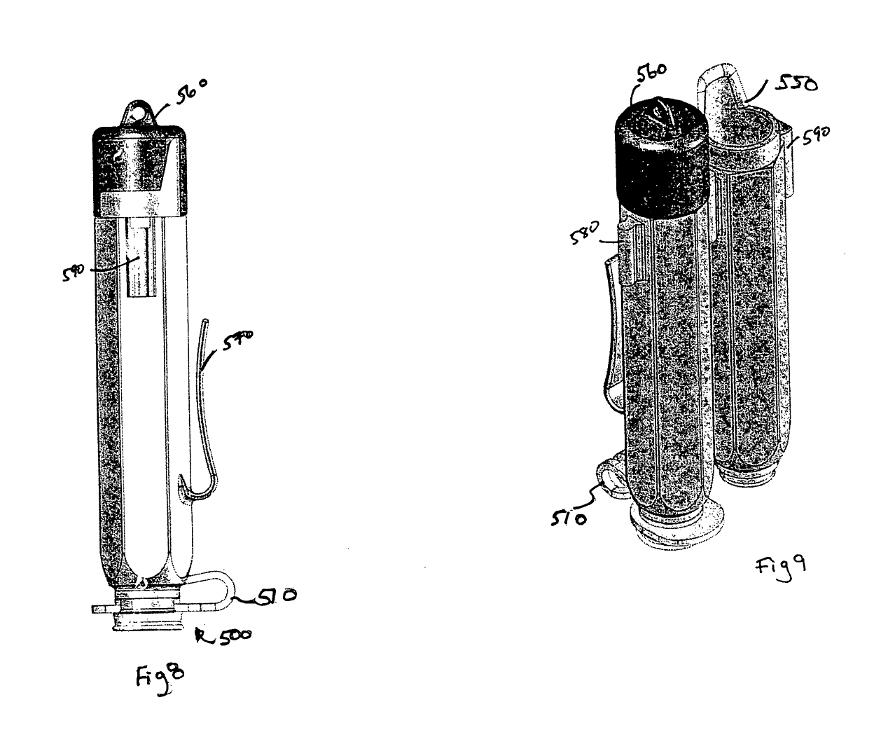

The scoop portion is designed so that it can easily fit into the mouth of any water bottle or drink bottle. In a preferred embodiment as shown in FIGS. 1-3, the scoop portion is squared, however in another embodiment shown in FIGS. 5-7, the scoop portion is rounded.

As can be seen in FIG. 1, one side of the cylinder contains a ‘male’ connector 130 while the opposite side contains a female connector 140. This allows an unlimited number of scooping units to be connected together.

As seen in FIGS. 4-7, another embodiment is shown where device 400 contains a rounded cap 410 which the body 420 for example, by screwing together, snapping on or any other type of attachment mechanism. Cap 410 is shaped like a spoon/scoop to allow the powder or other substance to be scooped or dispensed. As shown in FIGS. 5-6, when the cap is in place it can rotate 180 degrees in a clock wise or counter clock wise direction. The cap is rotated counter clock wise 180 degrees to be in the ‘open’ position. Actuation tabs 450 are attached to opposite sides of the cap so that the user can easily turn the cap to the open and closed positions by applying pressure to actuation tabs 450 with their fingers.

As can be seen in FIGS. 5-7, one side of the cylinder contains a ‘male’ connector 460 while the opposite side contains a female connector 470. This allows an unlimited number of scooping units to be connected together.

Also included, is a carrying clip 480 allowing the device to be attached to the user's belt or a bag. The device also contains a loop 490 allowing a key ring to be attached. This feature can be duplicated at the sealed end of the body.

In a preferred embodiment the device is made from the material Polypropylene, although other materials could be used such as Acrylonitrile Butadiene Styrene (ABS) or Polyethylene—Low Density (LDPE). The device can be disassembled so that it can easily cleaned and reused.

The user can fill the device with a powder or other substance prior to leaving for his training. When in need of re-hydration, the user, while in motion, can rotate the cap portion to open the device and pour the substance into a water bottle. The design of this device allows the user to use only one hand to open and dispense the powder into the water bottle. The device can then be put in a pocket or bag for later cleaning and reuse.

In another embodiment shown in FIGS. 8-9, the device consists of two open ends. This embodiment can also have only one open end (not shown). One end contains a cap 500 that consists of a ‘living hinge’ 510 (similar to a shampoo cap) as a closure mechanism. Cap 500 is opened by applying force at a point 180 degrees from hinge 510. The other end comprises a scoop 550. This device works similar to the preferred embodiment in that the powder substance can be scooped into the canister and secured therein. Once the user wants to mix the power with water, the user can either open the scoop end, or if on the move, the user can quickly snap off the cap and pour the powder into the water. A scoop cover 560 is provided to secure the powder inside the canister. This embodiment also contains a clip 570 for attaching the device to a belt or bag. In addition, male and female connectors, 580, 590, respectively, are added in order to attach multiple devices to each other.

The present invention allows the user to easily scoop up a powder of their choice. Once the powder is in the scoop it can be easily sealed and placed in the users pocket, attached to a key ring or clipped to a belt, strap or any other suitable location. When desired, the powder can be easily dispensed into any bottle or container holding a liquid. The present invention offers virtually unlimited capacity by allowing an unlimited number of units to be connected to each other. The unit is designed for one handed operation allowing the user to dispense the powder while in the midst of physical activity.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall there between.

What is claimed is:

1. A portable metered delivery system for sealably carrying and dispensing powder, comprising:
a tubular container having open and closed ends to receive and contain powder;
a removable cap comprising a base portion and a scoop portion, the removable cap projecting longitudinally from the open end of the tubular container to dispense the powder into a bottle;
an insert removably disposed between the tubular container and the removable cap, the insert comprising: an open section allowing the powder to pass through and a closed section for preventing release of the powder;
wherein the removable cap is rotated about the tubular container to expose the open section or closed section of the insert to open and close the system.

2. The system of claim 1 wherein the tubular container is multi-sided in shape.

3. The system of claim 2, wherein the removable insert comprises a multi-sided attachment portion for creating a snap fit with the tubular container.

4. The system of claim 1 wherein the removable cap further comprises actuation tabs for turning the cap from its open and closed positions.

5. The system of claim 1 wherein the tubular container contains male and female connectors to attach numerous systems together.

6. The system of claim 1 wherein the system can be disassembled for easy cleaning and reuse.

7. The system of claim 1 wherein the tubular container further comprises a hooking element for attachment to a belt or bag.

8. The system of claim 1 wherein the tubular container further comprises a loop element for attaching the system to a keychain.

9. A portable metered delivery system for sealably carrying and dispensing powder, comprising:
a tubular container having two open ends to receive and contain powder;
a snap cap being, attached to the tubular container with a hinge to one end of the tubular container;
a scoop shaped portion attached to the other end of the tubular container; and
a removable cap for closing the scoop portion to seal the powder in the tubular container.

10. The system of claim 10 wherein the tubular container is multi-sided in shape.

11. The system of claim 10 wherein the tubular container contains male and female connectors to attach numerous systems together.

12. The system of claim 10 wherein the tubular container further comprises a hooking element for attachment to a belt or bag.

13. The system of claim 10 wherein the tubular container further comprises a loop element for attaching the system to a keychain.

14. A portable metered delivery system for sealably carrying and dispensing substances, comprising:
a tubular container having open and closed ends to receive and contain the substance;
a removable cap comprising a base portion and a scoop portion, the removable cap projecting longitudinally from the open end of the tubular container to dispense the substance;
an insert removably disposed between the tubular container and the removable cap, the insert comprising, an open section allowing the substance to pass through and a closed section for preventing release of the substance;
wherein the removable cap is rotated about the tubular container to open and close the system.

15. The system of claim 14 wherein the tubular container is multi-sided in shape.

16. The system of claim 14, wherein the removable insert comprises a multi-sided attachment portion for creating a snap fit with the tubular container.

17. The system of claim 14 wherein the removable cap further comprises actuation tabs for turning the cap from its open and closed positions.

18. The system of claim 14 wherein the tubular container contains male and female connectors to attach numerous systems together.

19. The system of claim 14 wherein the tubular container further comprises a hooking element for attachment to a belt or bag.

20. The system of claim 14 wherein the tubular container further comprises a loop element for attaching the system to a keychain.
